(19) United States
(12) Patent Application Publication
(10) Pub. No.: US 2008/0169817 A1
(43) Pub. Date: Jul. 17, 2008

(54) Determining an Electric Field Based on Measurement from a Magnetic Field Sensor for Surveying a Subterranean Structure

(75) Inventors: Frank Morrison, Berkeley, CA (US); Stephen Allan Horne, Lafayette, CA (US); David Alumbaugh, Berkeley, CA (US); Jiuping Chen, Albany, CA (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar Land, TX (US)

(21) Appl. No.: 11/555,373

(22) Filed: Nov. 1, 2006

(51) Int. Cl. G01V 3/00

(52) U.S. Cl. 324/365

(57) ABSTRACT

To perform a survey of a subterranean structure behind a subsea surface, at least one sensor module is provided in a subsea environment, where the at least one sensor module comprises at least one magnetic field sensor. Measurement data is received from the magnetic field sensor, and an electric field along a particular direction is determined based on the measurement data to perform the survey of the subterranean structure, wherein the particular direction is generally orthogonal to the subsea surface.

### TECHNICAL FIELD

The invention generally relates to determining an electric field based on measurement data from a magnetic field sensor for surveying a subterranean structure behind a subsea surface.

### BACKGROUND

Various electromagnetic techniques exist to perform surveys of subterranean structures for identifying structures of interest, such as structures containing hydrocarbons. One such technique is the magnetotelluric (MT) survey technique that employs time measurements of naturally occurring electric and magnetic fields for determining the electrical conductivity distribution beneath the surface. Another technique typically used in subsea environments is the controlled source electromagnetic surveying technique, in which an electromagnetic transmitter is placed or towed in sea water. Surveying units containing electric and magnetic field sensors are deployed on a seabed within an area of interest to make measurements from which a geological survey of the subterranean structure underneath a seabed can be derived.

In one type of electromagnetic surveying technique, each of the surveying units includes horizontal electric field sensors, magnetic field sensors, and a vertical electric field sensor. The vertical electric field sensor is arranged in a vertical orientation relative to the generally horizontal seabed. However, this vertical electric field sensor is subjected to motion within the sea water, such as motion due to ocean currents, which provides a source of noise that may adversely affect accuracy.

### SUMMARY

In general, a sensor module is provided that has at least one magnetic field sensor to perform at least one magnetic field measurement. A vertical electric field can be determined based on the magnetic field measurement(s) such that a vertical electric field sensor does not have to be used.

Other or alternative features will become apparent from the following description, from the drawings, and from the claims.

### BRIEF DESCRIPTION OF THE DRAWINGS

FIG. 1 schematically illustrates an example arrangement for performing a survey of a subterranean structure underneath a seabed (or sea floor), in accordance with an embodiment.

FIGS. 2A-2B illustrate an arrangement of magnetic field sensors for making magnetic field measurements from which a vertical electric field can be derived, in accordance with an embodiment.

FIG. 3 is a chart containing several curves to illustrate simulated measured data values and calculations based on the simulated measured data values from the magnetic field sensors of FIGS. 2A-2B, in accordance with an embodiment.

FIGS. 4A-4B depict charts containing curves illustrating differences between vertical electric field values calculated for a subterranean structure containing a hydrocarbon layer and vertical electric field values calculated for a subterranean structure that does not contain a subterranean layer, based on calculations according to an embodiment.

FIG. 5 illustrates a toroidal sensor for making a magnetic field measurement from which a vertical electric field can be calculated, according to another embodiment.

FIGS. 6A-6B illustrate alternative techniques for obtaining gradients of magnetic fields, in accordance with some embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

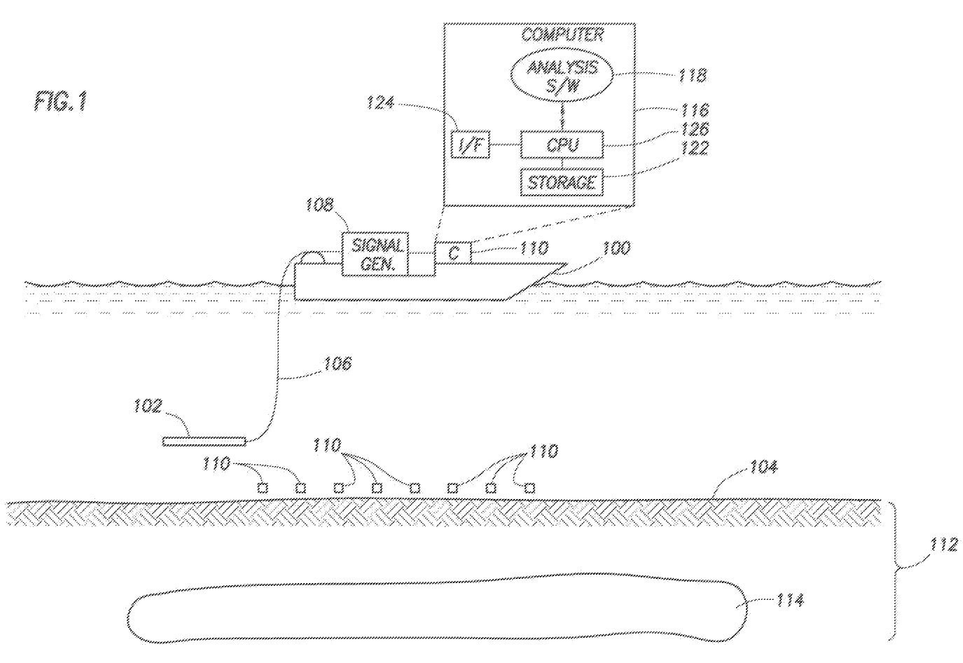

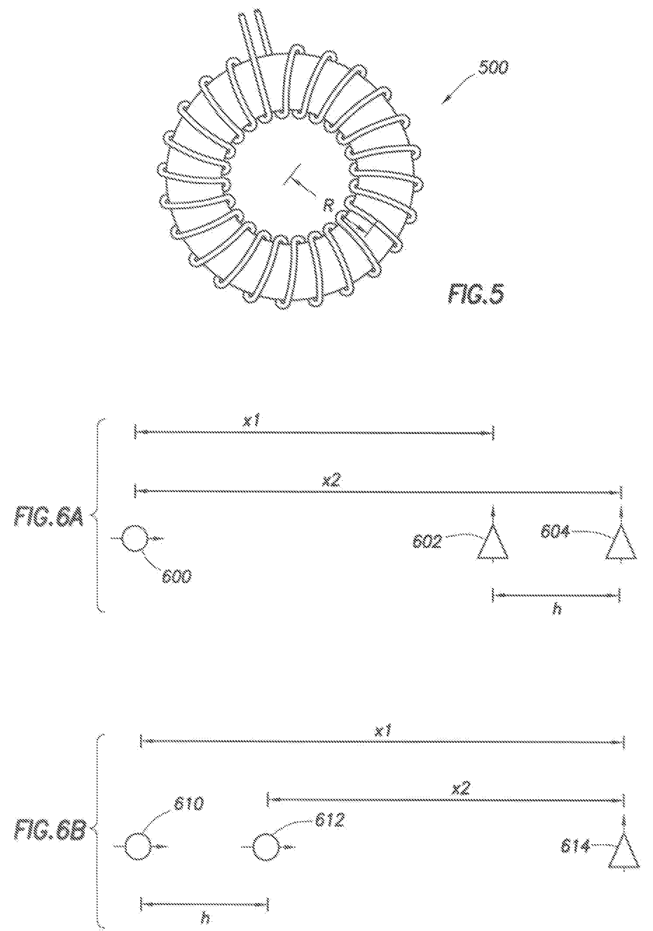

FIG. 1 illustrates an example arrangement for performing controlled source electromagnetic marine surveying. As depicted in FIG. 1, a sea vessel 100 is capable of towing an electromagnetic transmitter 102 in sea water. The electromagnetic transmitter 102 is an electrical dipole in one example embodiment. Typically, the electromagnetic transmitter 102 is arranged a relatively short distance above the seabed (or sea floor) 104. As examples, the relatively short distance of the transmitter 102 above the seabed 104 can be 50 meters or less. Although only one electromagnetic transmitter 102 is depicted, it is contemplated that alternative embodiments may use two or more electromagnetic transmitters 102 (described further below in connection with FIG. 6).

The electromagnetic transmitter 102 is coupled by a cable 106 to a signal generator 108 on the sea vessel 100. Alternatively, the signal generator 108 can be contained within the electromagnetic transmitter 102. The signal generator 108 controls the frequency and magnitude of the electromagnetic signal generated by the transmitter 102.

In one embodiment, a plurality of sensor modules 110 are arranged on the seabed 104. In the example of FIG. 1, the plurality of sensor modules 110 are arranged in a row. In other embodiments, the sensor modules 110 can have other arrangements (such as an array of sensor modules or some random arrangement of sensor modules).

Each sensor module 110 includes various sensors, including magnetic field sensors for making magnetic field measurements. In accordance with some embodiments, the magnetic field sensors are arranged in a predetermined pattern such that a vertical electric field can be computed based on the magnetic field measurements. The ability to compute the vertical electric field using magnetic field measurements avoids the need for including a vertical electric field sensor in each of the sensor modules 110. Eliminating the vertical electric field sensor allows for more compact sensor module designs, as well as removes a source of potential noise due to movement of the vertical electric field sensor due to sea water currents.

In another embodiment, described further in connection with FIG. 5 below, instead of using plural magnetic field sensors in each sensor module, one special type of magnetic field sensor can be employed. A vertical electric field can also be computed based on magnetic field measurement(s) made by this special type of magnetic field sensor.

The vertical electric field is a useful parameter for surveying the subterranean structure 112 underneath the seabed 104. In the example of FIG. 1, the subterranean structure 112 includes a layer 114 that has a reservoir of hydrocarbons. The hydrocarbon layer 114 is a relatively resistive layer (compared to the other parts of the subterranean structure 112). The presence of the resistive layer 114 in the subterranean structure 112 affects the vertical electric field that is readily noticeable. By using the surveying technique according to some embodiments, more efficient and accurate hydrocarbon exploration surveying of the subterranean structure 112 can be performed to enable the identification of the layer 114 containing hydrocarbons. In other implementations, the surveying technique can be used for other applications where surveying of subterranean structures is desirable.

The example configuration of the subterranean structure 112 depicted in FIG. 1 is an example of a one-dimensional halfspace configuration, which is the layer cake configuration where the subterranean structure 112 includes various layers that are generally horizontal and parallel to each other. However, the subterranean structure 112 can have a more complex configuration, such as an inhomogeneous halfspace configuration, where structures containing elements of interest (such as hydrocarbons) are two-dimensional in nature (e.g., rather than a generally horizontal layer of hydrocarbons, the inhomogeneous halfspace configuration may have a hydrocarbon-containing structure that has both horizontal and vertical components).

Although the discussion herein focuses on computing a vertical electric field based on measurement data from magnetic field sensors, it should be noted that electric fields in other directions can be calculated based on magnetic field sensors having other orientations relative to a subsea surface. In one example, as discussed above, the subsea surface is the seabed 104. However, in other examples, a subsea surface can have an inclined or even a vertical orientation. Measurement data from sensor modules arranged on such a non-horizontal subsea surface can be used to calculate an electric field in a direction that is generally orthogonal to the subsea surface. The term “generally orthogonal” is used in light of the fact that subsea surfaces, including the seabed 114, are not perfectly flat, so that the electric field computed is usually not perfectly orthogonal to the subsea surface. The term “vertical electric field” is also intended to cover situations where the seabed 104 may be at a slight angle such that the electric field derived from measurement data from magnetic field sensors would not be perfectly in the vertical direction, but would be substantially or generally in the vertical direction.

Each of the sensor modules 110 includes a storage device for storing measurements made by the various sensors, including magnetic field sensors, in the sensor module 110. The stored measurement data is retrieved at a later time when the sensor modules 110 are retrieved to the sea vessel 100. The retrieved measurement data can be uploaded to a computer 116 on the sea vessel 100, which computer 116 has analysis software 118 capable of analyzing the measurement data for the purpose of creating a map of the subterranean structure 112. The analysis software 118 in the computer 116 is executable on a central processing unit (CPU) 120 (or plural CPUs), which is coupled to a storage 122. An interface 124 that is coupled to the CPU 120 is provided to allow communication between the computer 116 and an external device. For example, the external device may be a removable storage device containing measurement data measured by the sensor modules 110. Alternatively, the interface 124 can be coupled to a communications device for enabling communications of measurement data between the computer 116 and the sensor modules 110, where the communications can be wired communications or wireless communications. The wired or wireless communications can be performed when the sensor modules 110 have been retrieved to the sea vessel 100. Alternatively, the wired or wireless communications can be performed while the sensor modules 110 remain on the sea floor 104.

Alternatively, instead of providing the computer 116 (and the analysis software 118) on the sea vessel 100, the computer 116 can instead be located at a remote location (e.g., at a land location). The measurement data from the sensor modules 11 can be communicated by a wireless link (e.g., satellite link) from the sea vessel 100 to the remote location. In yet another alternative, each sensor module 110 can include processing circuitry to process the measurement data and derive electric field values in accordance with some embodiments.

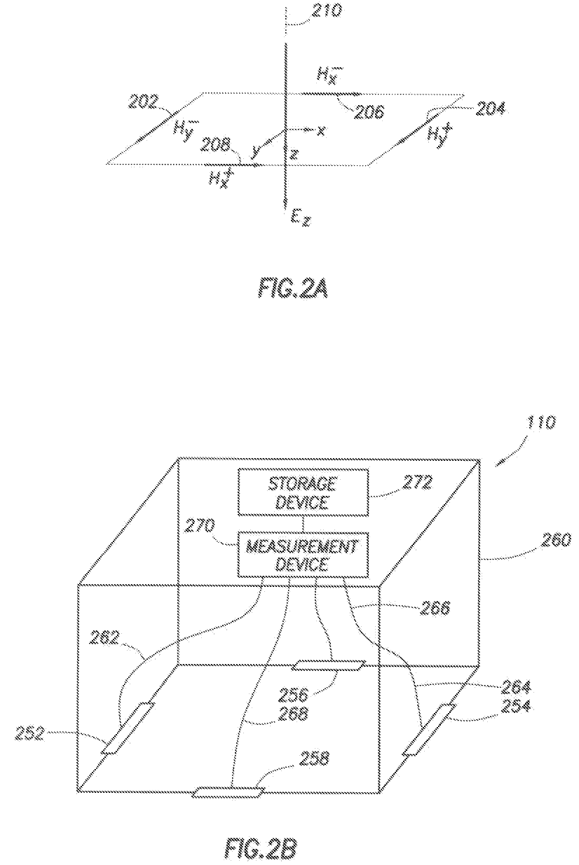

FIG. 2A is a schematic representation of various magnetic field intensities 202, 204, 206 and 208 in different respective orientations and locations. The magnetic field intensities 202, 204, 206 and 208 are measured by corresponding magnetic field sensors, such as sensors 252, 254, 256 and 258 that are part of a sensor module 110 depicted in FIG. 2B. The magnetic field sensors 252, 254, 256 and 258 can be magnetic induction coil sensors, where each such sensor includes a high magnetic permeability metallic cylindrical core around which an electrical wire is wound. As depicted in FIG. 2B, the magnetic field sensors 252, 254, 256 and 258 are attached to a housing 260 of the sensor module 110. Other sensors may also be provided in the sensor module 262, such as horizontal electric field sensors (not shown).

The magnetic field intensities 202 and 204 extend in a first direction (represented as a y direction or axis), while the magnetic field intensities 206 and 208 extend in a second, orthogonal direction (the x direction or axis). The y-direction magnetic field intensities 202 and 204 are represented as H⁻_{y} and H⁺_{y}, where the − symbol and + symbol are used to indicate relative position of the corresponding magnetic field with respect to a center vertical axis 210 (which is in another direction, the z direction or axis, that is orthogonal to both the x and y directions). The magnetic field intensity H⁻ₓ is on the negative side of the x axis, whereas the magnetic field intensity H⁺ₓ is on the positive side of the x axis.

Similarly, the x-direction magnetic field intensities 206 and 208 are represented as H⁻ₓ and H⁺ₓ . The magnetic field intensity H⁻_{y} is on the negative side of the y axis, whereas the magnetic field intensity H⁺_{y} is on the positive side of the y axis.

The magnetic field intensities H⁻_{y} and H⁺_{y} are magnetic field intensities in the y direction that are spaced apart along the x direction, while the magnetic field intensities H⁻ₓ and H⁺ₓ are magnetic field intensities in the x direction that are spaced apart along the y direction. From the magnetic field intensities H⁻_{y}, H⁺_{y}, H⁻ₓ and H⁺ₓ, a vertical electric field, represented as Eₓ, can be computed or derived without the need for using a vertically arranged electric field sensor. The vertical electric field Eₓ extends in the z direction.

As depicted in FIG. 2B, electrical wires 262, 264, 266, and 268 extend from respective sensors 252, 254, 256, and 258 to a measurement device 270. In some implementations, the measurement device 270 measures voltages provided by current flows in the electrical wires 262, 264, 266, and 268, respectively. The current flows in the electrical wires 262, 264, 266, and 268 are induced by corresponding magnetic field intensities H⁻_{y}, H⁺_{y}, H⁻ₓ and H⁺ₓ. The measured voltages are stored in a storage device 272 in the sensor module 110 for subsequent processing, such as by the computer 116 (FIG. 1). More generally, the measurement device 270 produces measurement data (e.g., measured voltages, measured currents, measured magnetic field values, etc.) that is stored in the storage device 272, which measurement data is subsequently processed to produce a vertical electric field value according to some embodiments.

To derive the vertical electric field from magnetic fields, techniques according to some embodiments make use of a fundamental physical relationship (Ampere's law) to relate spatial derivatives of magnetic fields to electric fields. Ampere's law states that the curl of a magnetic field, H, is equal to the electric current density, J:

V×H=J, (Eq. 1)

Combining Eq. 1 with Ohm's law,

J=σE, (Eq. 2)

which states that the electric current is equal to the product of the conductivity, σ, and electric field, E, yields Eq. 3 as provided below:

V×H=σE, (Eq. 3)

Thus the curl of the magnetic field is proportional to the electric field. If the vertical component of the electric field (E_{z}) is considered,

$$\hat{k} ( \frac{\partial {H}_{y}}{\partial x} - \frac{\partial {H}_{x}}{\partial y} ) = σ {E}_{z} , \qquad ( Eq . 4 )$$

where

$$\frac{\partial {H}_{y}}{\partial x}$$

is the partial spatial derivative of H in the x direction,

$$\frac{\partial {H}_{x}}{\partial y}$$

is the partial spatial derivative of H in the y direction, and k represents a unit vector (in the z direction).

Eq. 4 relates the spatial derivatives of the horizontal magnetic fields to the vertical electrical field. These spatial derivatives can be approximated using finite differences which, to a second order approximation, are

$$\begin{matrix}\text{?} & ( Eq . 5 ) \\ \frac{\partial {H}_{x}}{\partial y} ≅ \text{?} \\ \text{?} \text{indicates text missing or illegible when filed} & ( Eq . 6 )\end{matrix}$$

where H⁺_{y}, H⁻_{y}, H⁺ₓ, and H⁻ₓ are the magnetic field intensities illustrated in FIG. 2A that are capable of being measured using sensors 254, 252, 258, and 256, respectively.

In FIG. 2A, the H⁺ₓ and H⁻ₓ fields are separated (or spaced apart) by a distance in the y direction (Δy). Similarly the H⁺_{y} and H⁻_{y} field intensities are separated by a distance in the x direction (Δx). By measuring the changes of the horizontal magnetic field intensities in these directions (according to Eqs. 5 and 6 above), it is possible to calculate the vertical current density, J_{z}, and, using the electrical conductivity, the vertical electrical field E_{z}.

In operation, according to the arrangement of FIG. 1, the sensor modules 110 are arranged in the x direction, with the sensor modules 110 spaced apart from each other by some predetermined distance (e.g., 100 meters). Each sensor module 110 records measurement data based on magnetic field intensities sensed by corresponding magnetic field sensors in the sensor module 110. The electromagnetic transmitter 102 produces an electromagnetic signal at a predetermined frequency (e.g., between 0.1 Hz and 100 Hz) and at a predetermined magnitude. The measurements are taken along the x direction at every point (a point corresponds to a location of each sensor module, where two points are spaced apart) relative to the source, the electromagnetic transmitter 102. The measurement data recorded by the sensor modules 110 are stored (such as in the storage devices 272 (FIG. 2) in corresponding sensor modules).

Once the measurement data is provided to the analysis software 118 in the computer 116 (FIG. 1), the magnetic field intensities H⁺_{y}, H⁻_{y}, H⁺ₓ, and H⁻ₓ are readily derived. From the magnetic field intensities, the vertical electric field at each point (corresponding to a respective sensor module 110) along the x direction can be computed by the analysis software 118 using Eqs. 4-6 above.

In some embodiment, the analysis software 118 processes measurement data collected from the sensor modules 110 one at a time to derive the vertical electric field at the location of the corresponding sensor module 110. However, in accordance with another embodiment, measurement data from multiple sensor modules can be combined and processed to produce the vertical electric field. Thus, the measurement data from the multiple sensor modules can be used to derive magnetic field intensities H⁺_{y}, H⁻_{y}, H⁺ₓ, and H⁻ₓ associated with the multiple sensor modules 110, with the magnetic field intensities combined (such as averaged), which combined magnetic field intensities are used to compute the vertical electric field. In some implementations, if measurement data from multiple sensor modules are to be combined, then some procedure is used to ensure that the multiple sensor modules are aligned with respect to each other (in other words, the sensors 252, 254 of one sensor module are parallel to the sensors 252, 254 of another sensor module, and the sensors 256, 258 of one sensor module are parallel to the sensors 256, 258 of another sensor module). Alternatively, if the sensor modules cannot be aligned, then the amount of misalignment between sensor modules can be determined so that the misalignment can be accounted for when combining the measurement data.

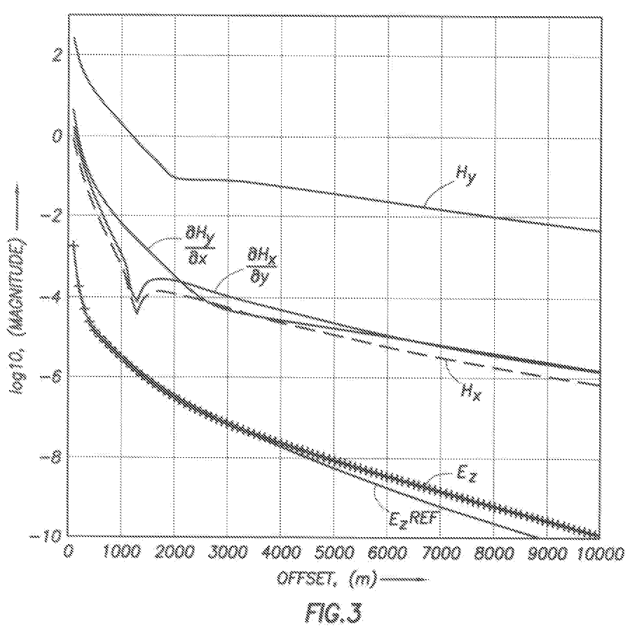

FIG. 3 shows several curves corresponding to example values for magnetic field intensities H_{y} and Hₓ, the spatial derivatives of these magnetic field intensity values, including

$$\frac{\partial {H}_{y}}{\partial x} and \frac{\partial {H}_{x}}{\partial y} ,$$

and electric fields Eₓ (the vertical electric field affected by the subterranean structure 112 containing the resistive layer 114) and E_{z}^{REF} (the vertical electric field when no resistive layer 114 is in the subterranean structure 112). The values of E_{z}^{REF} are plotted in FIG. 3 to illustrate the differences between E_{z}^{REF} and E_{z}. Note that H_{y} represents either H⁺_{y} or H⁻ₓ, and Hₓ represents either H⁺ₓ or H⁻ₓ. Due to the closeness of the H⁺_{y} and H⁻ₓ values, and the closeness of the H⁺_{y} and H⁻ₓ values, only one value from each pair are depicted for better clarity.

The vertical axis of the chart in FIG. 3 represents the log₁₀ magnitude, while the horizontal axis represents the offset (in meters) from a reference point (the electromagnetic transmitter 102). Note that the values represented in the charts are merely example values.

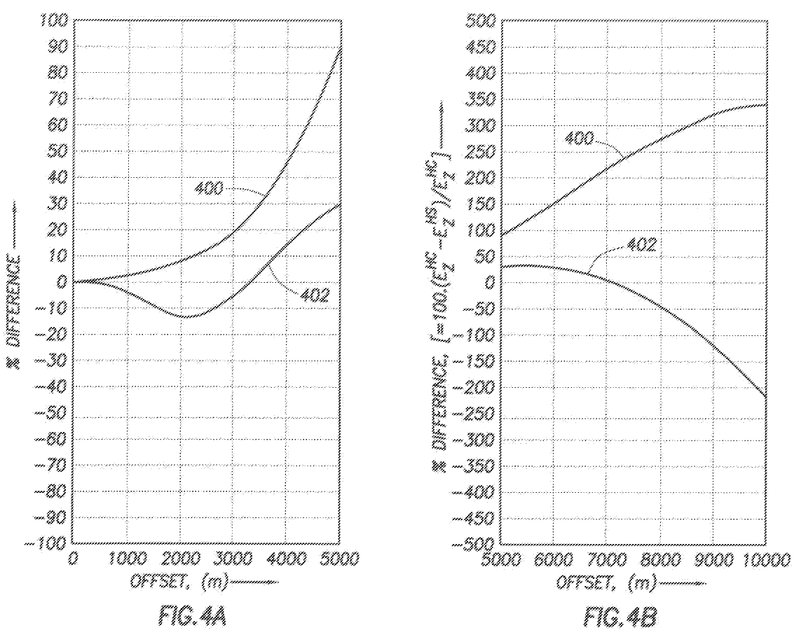

FIGS. 4A and 4B are charts for representing the percentage differences between E_{z} and E_{z}^{REF}. The vertical axis of the charts in FIGS. 4A and 4B represent the percent difference expressed as 100·[(Eₓ−E_{z}^{REF})/E_{z}]. FIG. 4A represents curves from offsets 0 to 5000 meters, while FIG. 4B represents curves from offsets 5000 to 10,000 meters. Curve 400 represents the percentage difference due to the imaginary (or out-of-phase) component of E_{z}, while curve 402 presents the percentage difference due to the real component of E_{z}. As indicated in FIGS. 4A-4B, there is a strong response in the vertical electric field E_{z} at offsets greater than about 3,000 meters, in the depicted example, especially in the imaginary component (curve 400) of E_{z}.

To provide the desired accuracy, the type of magnetic field sensor used in each sensor module 110 can be selected based on the noise levels and sensitivities of the magnetic field sensors at particular frequencies. Relatively sensitive magnetic field sensors would be able to make more accurate measurements, but may be susceptible to external noise such as minute movements in the earth's magnetic field. However, to compensate for such motion-based noise, two magnetic field sensors can be mounted on a rigid frame of the sensor module 110 in the spaced apart arrangements depicted in FIG. 2B.

The above discussion assumes use of a first type of magnetic field sensors with a cylindrical core around which electrical wires are wound. In another embodiment, a circular toroidal sensor 500 as depicted in FIG. 5 can be used in place of the magnetic field sensors 252, 254, 256, and 258 depicted in FIG. 2B. The toroidal sensor 500 is based on using the line integral formulation of Ampere's law

$$∮ H , dl = I , \qquad ( Eq . 7 )$$

which means that the line integral around a closed path is equal to the current I flowing normal to the plane of the path. If the toroidal sensor 500 is placed in a plane generally parallel to the seabed 104 (FIG. 1), then the current I flowing normal to the plane of the path would be the vertical current in the z direction that is affected by a resistive layer in the subterranean structure 112 as discussed above. The circular toroidal sensor 500 is arranged in a loop of radius R. The total current I normal to the plane of the toroid is

I=πR²J₂, (Eq. 8)

The toroid is wrapped on a high magnetic permeability metallic core of cross-sectional area α with a predetermined effective permeability (e.g., 200). Applying Ampere's law to the path containing the field within the core.

$$\begin{matrix}∮ H , d l = 2 π RH = π {R}^{2} J \text{?} & ( Eq . 9 ) \\ H = \frac{RJ \text{?}}{2} , \\ \text{?} \text{indicates text missing or illegible when filed} & ( Eq . 10 )\end{matrix}$$

Using the relationship of Eq. 10, the magnetic field H derived based on measurements by the sensor 500 of FIG. 5 can be used to calculate the vertical electric current density J_{z}. The toroidal sensor 500 of FIG. 5 can achieve the desired level of sensitivity to provide accurate measurements from which J_{z} can be computed.

In the discussion above, it is assumed that there is a single electromagnetic transmitter (e.g., 102 in FIG. 1). Alternatively, multiple electromagnetic transmitters can be used. This alternative embodiment involves gradients measured by using successive measurements of Hₓ and H_{y} for different positions of the transmitter. The rigorous application of Ampere's law

$$( \frac{\partial {H}_{y}}{\partial x} - \frac{\partial {H}_{x}}{\partial y} ) = {J}_{z}$$

requires that gradients be measured across baselines that are short (in other words, distances between sensor modules 110 are short) compared to the dimensions of the model of the subterranean structure 112 and for a fixed position of the source.

Since the vertical current density J_{z} is particularly sensitive to the presence of a resistor (resistive layer 114) at depth, measurements of gradients of H along the x and y directions that are proportional to J_{z} but not necessarily equal to it would be valuable parameters for resolving the model. Approximate gradients of H can be synthesized by differencing the fields measured by a single sensor module for two spatial positions of the source (electromagnetic transmitter), unlike the previous embodiments where differences are taken for a single source and two spatial positions of the sensor modules.

FIG. 6B depicts an x-directed first electromagnetic transmitter 610 (similar to electromagnetic transmitter 102 in FIG. 1) located a distance xI from a sensor module 614, which measures the magnetic field intensity in the y direction, H_{y1}, A second electromagnetic transmitter 612 is located at a second position x2 a distance h from x1. The sensor module 614 in this case measures the magnetic field intensity, H_{y2}, in the y direction. Note that the first and second electromagnetic transmitters 610 and 612 can be two different electromagnetic transmitters that concurrently produce electromagnetic signals. Alternatively, the first and second electromagnetic transmitters 610 and 612 can be a single transmitter moved between two different positions, where the electromagnetic transmitter produces a first electromagnetic signal at a first position, and produces a second electromagnetic signal at a second position spaced apart from the first position.

The difference H_{y2}-H_{y1} divided by h (gradient of H_{y} in the x direction) is approximately the same as the difference in field between two sensor modules 602 and 604 a distance h apart for a fixed transmitter 600 at position (x2+x1)/2, ad depicted in FIG. 6A. This equivalence is exact over a one dimensional halfspace (layer cake arrangement of the subterranean structure where the layers are generally horizontal), but is only approximately true over an inhomogeneous halfspace (arrangement of the subterranean structure where a resistive structure may extend in three dimensions).

Similarly the Hₓ gradient in the y direction is obtained from a transmitter (or plural transmitters) displaced by h in the y direction. This is exactly equivalent to the gradient obtained with two receivers separated by h in the y direction.

A benefit of this scheme is that a particular gradient sensitivity (e.g., 1 fT/m or femto-Tesla per meter) to achieve an adequate resolution of Jₓ can be achieved with sensors of lower sensitivity (e.g., 100 fT resolution separated by 100 m). Consequently, existing sensors having noise levels of 200 fT at 0.3 Hz can be used to determine J_{z} to the desired accuracy if position accuracy or parallel transmitter tracks can be obtained.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

1. A method comprising:
providing at least one sensor module in a subsea environment, wherein the at least one sensor module comprises at least one magnetic field sensor;
receiving measurement data from the magnetic field sensor; and
determining an electric field along a particular direction based on the measurement data to perform a survey of a subterranean structure behind a subsea surface, wherein the particular direction is generally orthogonal to the subsea surface.

2. The method of claim 1, wherein the at least one sensor module comprises plural magnetic field sensors, wherein the measurement data is received from the plural magnetic field sensors, and wherein determining the electric field along the particular direction is based on measurement data from the plural magnetic field sensors.

3. The method of claim 2, further comprising:
arranging the plural magnetic field sensors to measure two magnetic field intensities in a first direction spaced apart along a second direction, and to measure two magnetic field intensities in the second direction spaced apart along the first direction, wherein the first and second directions are orthogonal.

4. The method of claim 3, wherein the two magnetic field intensities in the first direction are spaced apart by a first distance, and the two magnetic field intensities in the second direction are spaced apart by a second distance, and wherein determining the electric field comprises computing a first value and a second value, the first value equal to a difference of the two magnetic field intensities in the first direction divided by the first distance, and the second value equal to a difference of the two magnetic field intensities in the second direction divided by the second distance.

5. The method of claim 4, wherein the two magnetic field intensities in the first direction are expressed as H_{y}⁻and H_{y}⁺, the two magnetic field intensities in the second direction are expressed as H_{×}⁻and H_{×}⁺, the first distance is expressed as Δ×, the second distance is expressed as Δy, and wherein determining the electric field is based on calculating
$$( \frac{\partial {\text{?}}_{y}}{\partial x} - \frac{\partial H \text{?}}{\partial y} ) ,$$
$$\text{?} \text{indicates text missing or illegible when filed}$$
wherein is a partial spatial derivative in the second
$$\frac{\partial {H}_{y}}{\partial x}$$
direction, and
$$\frac{\partial {H}_{x}}{\partial y}$$
is a partial spatial derivative in the first direction, and wherein
$$( \frac{\partial {H}_{y}}{\partial x} - \frac{\partial H }{\partial y} )$$
is approximated for determining the electric field by setting
$$\frac{\partial H \text{?}}{\partial x} ≅ \frac{H \text{?}}{Δ x}$$
$$\text{?} \text{indicates text missing or illegible when filed}$$
and
$$\frac{\partial H \text{?}}{\partial y} ≅ \frac{H \text{?} - H }{Δ y} . \\ \text{?} \text{indicates text missing or illegible when filed}$$

6. The method of claim 1, wherein determining the electric field based on the measurement data comprises determining a vertical electric field based on the measurement data to perform the survey of the subterranean structure underneath a seabed.

7. The method of claim 1, further comprising:
providing additional sensor modules, where each of the additional sensor modules comprises at least one magnetic field sensor;
receiving measurement data from the at least one magnetic field sensor of each of the additional sensor modules; and
determining electrical fields along the particular direction based on the corresponding measurement data of the additional sensor modules to perform the survey of the subterranean structure.

8. The method of claim 1, further comprising:
providing at least one additional sensor module, where the at least one additional sensor modules comprises at least one magnetic field sensor;
receiving measurement data from the at least one magnetic field sensor of the at least one additional sensor module;
combining the measurement data of the sensor modules,
wherein determining the electrical field is based on the combined measurement data.

9. The method of claim 1, wherein providing the at least one sensor module having the at least one magnetic field sensor comprises providing a toroidal magnetic field sensor.

10. The method of claim 9, wherein the toroidal magnetic field sensor has a radius R and measures a magnetic field H, and wherein determining the electric field comprises determining the electric field according to
$$H = \frac{RJz}{2} ,$$
wherein the electric field is equal to J_{z} divided by conductivity σ.

11. The method of claim 1, further comprising:
storing the measurement data in a storage device of the sensor module; and
retrieving the sensor module from the subsea environment to obtain the measurement data,
wherein the electric field is computed by a computer into which the measurement data is provided.

12. The method of claim 1, further comprising providing an electromagnetic transmitter to produce an electromagnetic signal, wherein the measurement data from the sensor module is based on the electromagnetic signal.

13. The method of claim 1, further comprising providing plural spaced apart electromagnetic transmitters to produce electromagnetic signals, wherein the measurement data from the sensor module is based on the electromagnetic signals.

14. The method of claim 1, further comprising providing an electromagnetic transmitter at a first location to produce a first electromagnetic signal, and providing the electromagnetic transmitter at a second location to produce a second electromagnetic signal, wherein the measurement data from the sensor module is based on the first and second electromagnetic signals.

15. A system comprising:
at least one sensor module in a subsea environment, wherein the at least one sensor module comprises at least one magnetic field sensor;
a storage device to store measurement data from the magnetic field sensor; and
a computer to calculate an electric field along a particular direction based on the measurement data to perform a survey of a subterranean structure behind a subsea surface, wherein the particular direction is generally orthogonal to the subsea surface.

16. The system of claim 15, wherein the at least one sensor module comprises plural magnetic field sensors, and the storage device stores measurement data from the plural magnetic field sensors, the computer to calculate the electric field along the particular direction based on measurement data from the plural magnetic field sensors.

17. The system of claim 16, wherein each magnetic field sensor comprises a cylindrical core around which an electrical wire is wound.

18. The system of claim 16, wherein the plural magnetic field sensors are arranged to measure two magnetic fields in an × direction spaced apart along a y direction, and to measure two magnetic fields in the y direction spaced apart along the × direction.

19. The system of claim 15, wherein the electric field is a vertical electric field used to perform the survey of the subterranean structure underneath a seabed.

20. The system of claim 15, further comprising:
additional sensor modules, where each of the additional sensor modules comprises at least one magnetic field sensor;
additional storage devices to store corresponding measurement data from the at least one magnetic field sensor of each of the additional sensor modules; and
the computer to calculate electrical fields along the particular direction based on the corresponding measurement data of the additional sensor modules to perform the survey of the subterranean structure.

21. The system of claim 15, wherein the at least one magnetic field sensor comprises a toroidal magnetic field sensor.

22. The system of claim 15, further comprising an electromagnetic transmitter to produce an electromagnetic signal, wherein the measurement data from the sensor module is based on the electromagnetic signal.

23. The system of claim 15, further comprising plural electromagnetic transmitters to produce electromagnetic signals at plural corresponding positions, wherein the measurement data from the sensor module is based on the plural electromagnetic signals.

24. A sensor module comprising:
a first pair of magnetic field sensors to measure first direction magnetic fields, the first pair of magnetic field sensors spaced apart by a first distance along a second direction; and
a second pair of magnetic field sensors to measure second direction magnetic fields, the second pair of magnetic field sensors spaced apart by a second distance along the first direction, wherein the first direction is orthogonal to the second direction,
wherein an electric field is computable from the first direction magnetic fields and second direction magnetic fields.

25. (canceled)

26. (canceled)
